(19) United States
(12) Patent Application Publication
(10) Pub. No.: US 2004/0012684 A1
(43) Pub. Date: Jan. 22, 2004

(54) Image reconstruction techniques for charge coupled devices

(75) Inventor: Natale Tinnerino, Morgan Hill, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Fairchild Imaging, Milpitas, CA

(21) Appl. No.: 10/198,713

(22) Filed: Jul. 16, 2002

(51) Int. Cl. H04N 5/228

(52) U.S. Cl. 348/208.1

(57) ABSTRACT

Techniques are provided for producing video data using a sensor with charge coupled devices. Signals from the CCD pixels are alternately stored into one set of memory devices and read out of another set of memory devices. Once the signals from the pixels are read out of the memory devices, they are used to produce video frames. The orientation of each portion of the frames is independent of the direction the signals are read out of each of the charge coupled devices. The orientation of each portion of the frames is independent of the physical orientation of the CCDs in the x,-y plane. The pixel signals from the CCDs can be used to produce video data in near real-time. The image reconstruction techniques can be re-programmed to account for different CCD focal plan configurations and orientations.

### BACKGROUND OF THE INVENTION

The present invention involves techniques for reconstructing a video image using an imaging device, and more particularly, to techniques for reconstructing an image from a plurality of tiled charge coupled devices in near real-time.

Charge coupled devices (CCDs) are made up of contiguous photodetecting picture elements (pixels) formed on a semiconductor wafer. The pixels can detect light and output electrical signals in response to the light.

Output electrical signals are proportional to the intensity of the impinging light rays, and can be processed, digitized, stored and reconstructed to produce an image of the object. CCDs are very sensitive to light. Therefore, the image produced can be a very accurate reproduction of the object. CCDs can be used to build an imaging device or a camera.

CCDs are usually formed on a semiconductor wafer that is a few inches in width. The small size of a typical CCD limits the light sensing area of the imaging device. It would therefore be desirable to provide an imaging device that has a larger light sensing area than a typical single CCD. It would also be desirable to provide an imaging device that provides a fast enough frame rate to be used as a video camera.

### BRIEF SUMMARY OF THE INVENTION

The present invention provides techniques for producing video from a plurality of tiled charge coupled devices. A plurality of charge coupled devices can be combined in tiled M×N arrays to achieve a larger imaging area. The charge coupled devices sense electromagnetic radiation (e.g., light) and produce video frames.

According to the principles of the present invention, an image is formed such that the orientation of each portion of the image sensed by a CCD is preserved. The orientation of each portion of the image is independent of the direction signals are read out of the CCDs. Without the techniques of the present invention, the orientation of portions of the image may be different with respect to each other. For example, one portion of an image sensed by one CCD may be rotated with respect another portion sensed by a second CCD.

According to the present invention, separate memory devices are associated with each of the charge coupled devices in a tiled CCD array. Image signals from each CCD are stored in memory devices associated with that CCD. The image signals from a CCD are stored and read out of the memory devices in configurations that are independent of the direction that signals are read out of each CCD. The image signals are read out of the memory devices in near real-time and used to form video frames on a display at the desired orientation.

The present invention provides CCD imaging devices that have a fast enough frame rate to be used for outputting video data. By storing the image signals from each CCD in separate memory devices, pixels can be read out of a plurality of CCD sensors and stored in memory devices associated with each CCD at the same speed as a single CCD sensor. At the same time, signals can be read out of the memory devices at a fast frame rate (e.g., up to M×N times individual CCD sensor pixel rates). The frame rate of the output video is also increased because image signals for one frame are stored in a first set of memory devices, while image signals for another frame are simultaneously read out of a second set of memory devices and used to reconstruct a video frame.

### BRIEF DESCRIPTION OF THE DRAWINGS

FIG. 1 illustrates a 2×2 array of charge coupled devices of one channel each and associated circuitry in accordance with the present invention;

FIGS. 2A-2B illustrate how the orientation of portions of the output image sensed by a tiled array of charge coupled devices is changed with respect to light from the original object when the image reconstruction principles of the present invention are not used;

FIG. 3 illustrates image reconstruction circuitry for a 2×2 array of charge coupled devices of one channel each in accordance with the present invention;

FIG. 4 illustrates image reconstruction circuitry for a charge coupled device with four channels in accordance with the present invention;

FIG. 5 illustrates how the output signals from memory circuits associated with each of 4 charge coupled devices of 3 channels each are multiplexed together in accordance with the present invention;

FIG. 6 illustrates a 2×2 array of charge coupled devices of 3 channels each with pixels that are divided into a total of 12 channels in accordance with the present invention;

FIG. 7 is a graph that illustrates pulsed light mode operation for a camera with 4 CCDs in a 2×2 array that have 3 channels per FIG. 6;

FIG. 8 is a graph that illustrates continuous mode operation for a camera with 4 CCDs in a 2×2 array that have 3 channels each per FIG. 6;

FIG. 9 illustrates signal processing circuitry for signals from one charge coupled device (CCD) with 8 channels according to the present invention;

FIG. 10 illustrates further details memory storage devices for signals from one CCD with 8 channels and associated circuitry in accordance with the present invention;

FIG. 11A illustrates a 2×2 array of charge coupled devices (CCDs) with 8 channels each in accordance with the present invention; and

FIGS. 11B-11C illustrate graphs of the read output signals of memories for a 2×2 array of CCDs with 8 channels each in accordance with the present invention.

### DETAILED DESCRIPTION OF THE INVENTION

FIG. 1 illustrates a 2×2 array of charge coupled devices (CCDs) and circuitry integrated on the same chip used to transfer charge signals out of the CCDs. CCDs 111-114 each include a plurality of pixels (not shown). The pixels are also referred to as photosites. The pixels are arranged in a plurality of rows and columns. The rows extend horizontally and the columns extend vertically in each of CCDs 111-114. For example, a CCD may include 2048 rows and 2048 columns of pixels.

The circuitry associated with each CCD includes transmission gates 127, vertical summing wells 121, horizontal shift registers 122, transmission gate 123, summing well 124, transmission gate 125, and amplifier circuit 126. Each vertical summing well 121 is coupled to one column of pixels and to one of the horizontal shift registers 122.

Photosites in the CCDs can sense electromagnetic radiation within a particular range of wavelengths. For example, CCDs may be able to sense visible light, ultraviolet light, and infrared light. When light impinges upon the photosites in a CCD, charge signals representing image data are formed in the photosites.

Vertical shift registers (not shown) associated with each column of pixels are used to transfer the charge signals out of the CCDs and into horizontal shift registers 122 through transmission gates 127. One or more clock signals are used to control the transfer of charge signals from one row of pixels to another row using the vertical shift registers.

In each period of one or more vertical clock signals, charge signals from the pixels are transferred from one row to another in vertical shift registers, until they reach the edge of the CCD imaging area at the input to parallel transmission gates 127. Once signals reach the parallel transmission gates 127 they are summed in vertical summing wells 121. The summed signals are then stored in horizontal shift registers 122.

The opening and closing of transmission gates 127 may also be controlled by a clock signal. Transmission gates 127 control how many rows of pixel signals are summed together in vertical summing wells 121. Horizontal shift registers 122 temporarily store the charge signals.

Signals generated in two or more rows of pixels can be summed together in an analog fashion in vertical summing wells 127, or alternatively, in horizontal shift registers 122. This technique is called vertical binning. For example, signals generated in a first row of pixels can be stored in summing wells 121 or registers 122 in one period of a clock signal. In the next period of the clock signal, signals generated in a second row of pixels are summed to signals from the first row of pixels that are in the same column of pixels. The signals generated in the first and second rows of pixels are added together in an analog fashion.

If the pixel signals are summed together in vertical summing wells, the binned signals are subsequently stored in horizontal shift registers 122. Each column of pixels is stored in a corresponding register.

After the charge signals from a selected number of rows are added together, the summed charge signals are shifted out of registers 122 by one or more horizontal clocks into summing well 124 via transmission gate 123. Transmission gate 123 may also be controlled by a clock signal. Another one or more clock signal control the shifting of charge signals across horizontal shift registers 122 and into summing well 124.

Charge signals from multiple columns of pixels can be added together in an analog fashion in summing well 124. This method is also part of the binning technique mentioned above. For example, transmission gate 123 can allow charge signals from four columns of pixels to be transferred into summing well 124. The charge signals from the four columns of pixels are added together in an analog fashion in summing well 124.

Transmission gate 125 is also controlled by a clock signal. Transmission gate 125 allows the summed charge signal in summing well 124 to be transferred to buffer 126. Buffer 126 buffers the signal from summing well 124 and outputs the signal to additional circuitry for further image processing.

The number of vertical and horizontal transfers that occur while transmission gates 127 and 123 are opened determines how many rows and columns of pixel signals are added together in a particular binning configuration. Transmission gates 127 and 123 may be open for longer periods to sum charge signals from more rows and columns of pixels together in the summing wells.

In an alternative embodiment, signals from columns of the pixels can be summed together in summing wells first. Subsequently, signals from rows of the pixels are summed together in summing wells (or registers). Thus, signals from the rows and columns of pixels can be summed in either order.

In a 4×4 binning technique, charge signals from four rows of pixels are added together, and the summed charge signals from four columns of pixels are added together. Thus, charge signals from a total of 16 pixels (in 4 rows and 4 columns) are ultimately combined in summing well 124 and then amplified by amplifier 126. In a 2×2 binning technique, charge signals from 4 pixels (2 rows and 2 columns) are combined.

Binning charge signals from multiple pixels in a CCD provides a way to increase the strength of weak signals and to increase the signal-to-noise ratio of the CCD output signals as well as increasing the image data transfer rate. However, these advantages come at the expense of reduced image resolution.

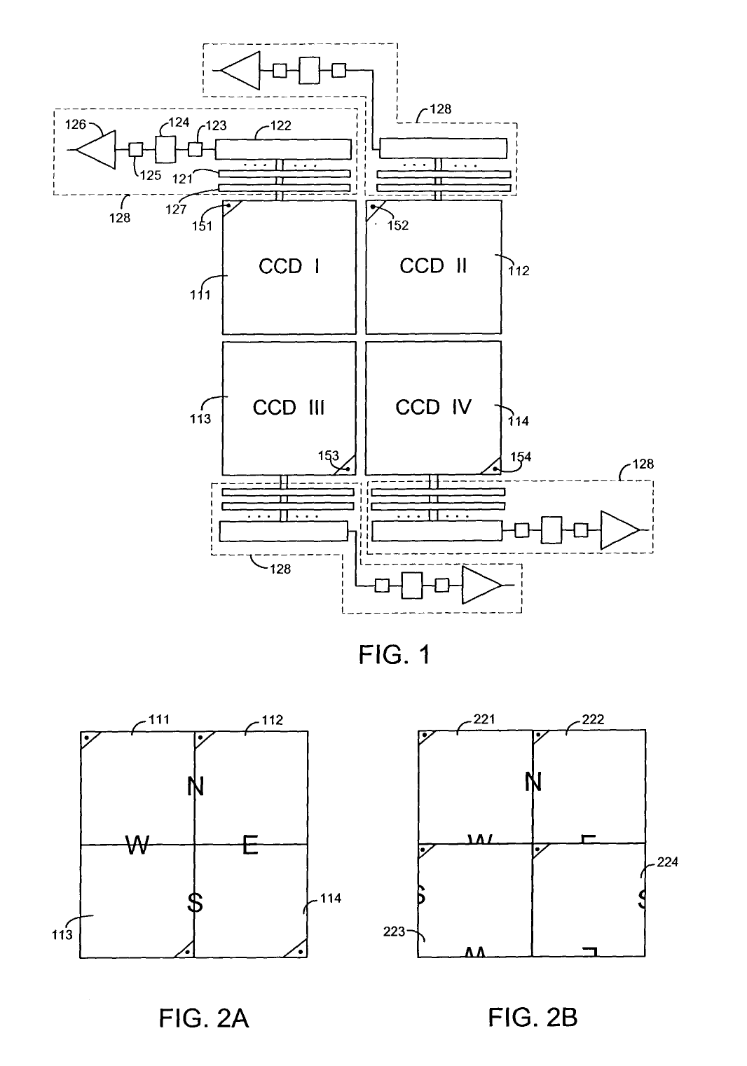

FIGS. 2A-2B illustrate how the orientation of portions of the output image sensed by a tiled array of CCDs can be changed with respect to the original image when the principles of the present invention are not used. CCDs 111-114 form a 2×2 tiled array that senses light from an object. Light from the letters N, E, S, and W falls onto CCDs 111-114 as shown in FIG. 2A. Each of the letters N, E, S, and W overlaps two adjacent CCDs.

Image signals are read out of CCDs 111-114 using horizontal and vertical shift registers that are oriented as shown in FIG. 1. The corners of CCDs 111-114 have marks 151-154 near the corners where the outputs of the horizontal shift registers are coupled to the summing wells. Marks 151-154 indicate the direction that a CCD outputs the image signals.

The horizontal shift registers shift out the image signals beginning with the first row and the first column of pixels at marks 151-154. The image signals from each CCD are then used to produce one video frame. Without the techniques of the present invention, the orientation of portions of the reconstructed video image output from CCDs 111-114 is undesirably shifted with respect to the original image pattern shown in FIG. 2A.

FIG. 2B illustrates the output video frame that results from the shifted image pattern caused by CCDs scanning per FIG. 1. The image in frame portion 221-222 have the same orientation as the image patterns falling on CCDs 111-112, respectively, in FIG. 2A. The images in frame portion 223-224 have different orientations than the light patterns that fall on CCDs 113-114, respectively, in FIG. 2A.

The output video frame shown in FIG. 2B is distorted, because CCDs 113-114 have a different orientation than CCDs 111-112.

The first row of pixels read out of CCD 111 is the top row (i.e., the row closest to vertical summing well 127). Signals from subsequent rows of pixels read out of CCD 111 are displayed in subsequent rows of frame portion 221 (from the top to the bottom of frame portion 221). Signals from the first column of pixels (i.e., the column closest to mark 151) read out of CCD 111 are displayed in the left column of frame portion 221. Signals from subsequent columns of pixels are displayed in subsequent columns of frame portion 221 (from the left to the right of frame 221). The same is the case for CCD 112 and corresponding frame portion 222.

The output frames are displayed in exactly the same pattern for each frame portion 221-224 (from the top to the bottom and from the left to the right of the frame portion), regardless of how pixel signals are read out of a particular CCD sensor. The problem is that signals from the rows of pixels are read out of CCDs 113-114 from the bottom to the top, because registers 122 are coupled to the bottom of CCDs 113-114. However, the pixel signals are displayed in frame portions 223-224 from the top to the bottom. Therefore, frame portions 223-224 display images that are flipped upside down with respect to the image pattern shown in FIG. 2A.

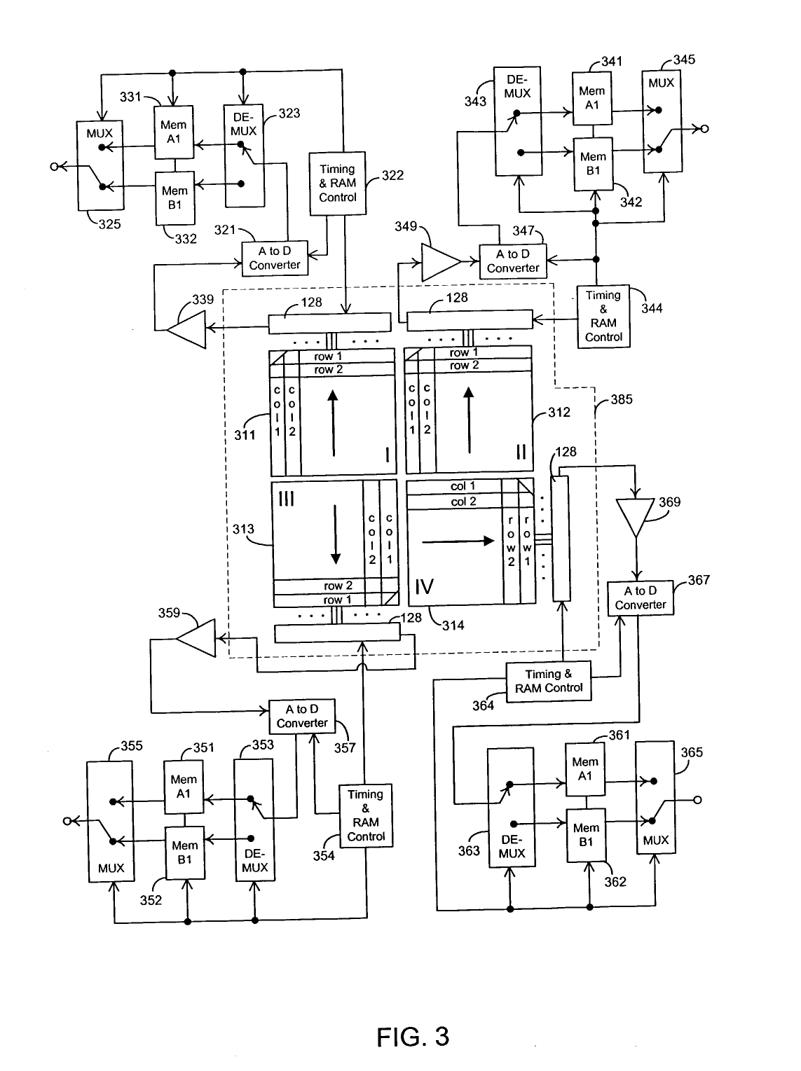

Next, techniques for reconstructing an image exactly as it is sensed by the CCDs in a tiled array are described. For example, the image discussed above can be reproduced exactly as it appears in FIG. 2A. FIG. 3 illustrates an embodiment of the present invention that provides an image exactly as it is sensed by a tiled array of CCDs.

The image reconstruction circuitry shown in FIG. 3 includes a 2×2 array of charge coupled devices (CCDs) 311-314. Each of CCDs 311-314 is coupled to the circuitry 128 details of which are shown in FIG. 1 and discussed above. Circuitry 128 is coupled to an amplifier 339. Circuitry 128 may be fabricated on the same semiconductor wafer as the corresponding CCD. The circuitry outside box 385 is typically fabricated on separate semiconductor wafers or chips though the invention is not limited as such.

The additional circuitry outside box 385 is now discussed in further detail. Amplifier 339 amplifies the output signals of buffer 126 (FIG. 1). The output of amplifier 339 is provided to an input of analog-to-digital converter 321 (which includes analog signal processor). A-to-D converter 321 converts the analog output signals of amplifier 339 (after signal processing) into digital signals.

The digital signals from A-to-D converter 321 are provided to the input of de-multiplexer 323. De-multiplexer 323 has two output terminals that are coupled to random access memory (RAM) circuits 331 and 332. Memory circuits 331 and 332 are also coupled to input terminals of multiplexer 325.

Timing and RAM control circuit 322 outputs a plurality of signals that control circuitry 128, A-to-D converter 321, memory circuits 331 and 332, multiplexer 325, and de-multiplexer 323. Clock signals from timing and RAM circuit 322 control the transfer of signals into and out of horizontal shift registers 122, and the opening and closing of transmission gates 127, 123, and 125 (FIG. 1). Another clock signal from circuit 322 controls the passage of signals through A-to-D converter 321. Thus, the timing of these clock signals determines the data transfer rate through horizontal shift registers 122, summing well 125, and A-to-D converter 321.

A first select signal from circuit 322 selects the input terminal of one of SRAM circuits 331, 332 to which the input terminal of de-multiplexer 323 is coupled. Another select signal from circuit 322 selects the output terminal of one of SRAM circuits 331, 332 to be coupled to the output terminal of multiplexer 325.

These two select signals are timed such that when de-multiplexer 323 couples its input terminal to the input of memory circuit 331, multiplexer 325 couples the output of memory circuit 332 to its output terminal, and when de-multiplexer 323 couples its input terminal to the input of memory circuit 332, multiplexer 325 couples the output of memory circuit 331 to its output terminal. The waveforms of the select signals may, for example, have the same shape and the same period, while being out of phase with each other.

Signals indicative of a first video frame are written into memory circuit 331 during a first period of time, and signals indicative of a second video frame are written into memory circuit 332 during a second period of time. When signals received from A-to-D converter 321 are being written in memory circuit 331, signals are read out of memory circuit 332 and transferred to the output of multiplexer 325, thus achieving parallel signal processing. Signals appearing at the output of multiplexer 325 are used by the imaging device to produce video frames.

Each of the other three CCDs are coupled to similar circuit blocks for processing pixel signals in a similar manner to that described above. Amplifiers 349, 359, and 369 all amplify the output signals of corresponding circuit elements 128. A-to-D converters 347, 357, and 367 convert the signals output by the amplifiers to digital signals. Timing and RAM control circuits 344, 354, and 364 control the timing of the other circuit elements as discussed with respect to timing and RAM control 322. De-multiplexes 343, 353, and 363 cause signals output by the A-to-D converters to be written into corresponding memory circuits 341/351/361 or memory circuits 342/352/362 as discussed above with respect to de-multiplexer 323. Multiplexers 345/355/365 output signals provided by corresponding memory circuits 341/351/361 or memory circuits 342/352/362 as discussed above with respect to multiplexer 325.

Referring now to FIG. 5, the output of multiplexers 325, 345, 355 and 365 are combined into one video stream via 4 to 1 multiplexer 399. Multiplexer 399 outputs each signal in the proper sequence via control signals from timing RAM controls 322, 344, 354 and 364.

CCDs of the present invention can be divided into channels. For example, FIG. 6 illustrates an array of four CCDs 611-614. Each CCD 611-614 has rows and columns of pixels that are in turn divided into three channels. The channels are labeled 1-12. The pixel signals from each channel in a CCD channel are stored and processed by separate circuit elements (including separate registers, summing wells, amplifiers, A-to-D converters, memory circuits, etc.).

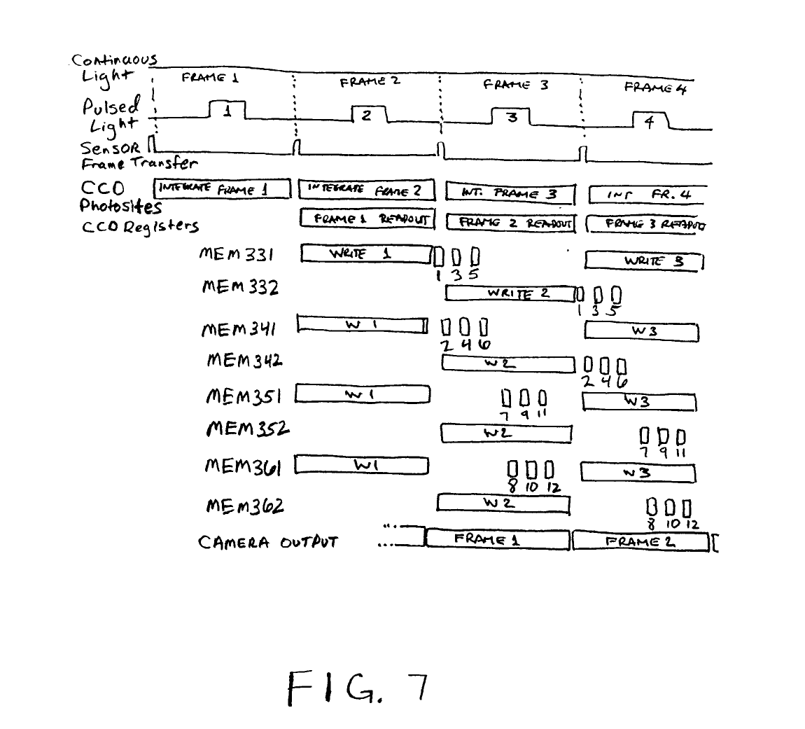

FIG. 7 illustrates a process of writing signals from CCDs into the memory circuits. CCDs may be exposed to frames of light from an object or light source. The frames of light may, for example, last only for discrete time intervals as shown in FIG. 7. When the CCDs are exposed to frame 1 of the light, charge signals are formed in the photosites. The signals indicate the light pattern sensed by the pixels. After the exposure period for frame 1 ends, the signals are read out of the CCDs using the vertical shift registers and the horizontal shift registers.

The signals from each CCD are converted to digital signals using A-to-D converters 321, 347, 357, and 367. During the readout period, de-multiplexers 323, 343, 353, and 363 couple their input terminals to memory circuits 331, 341, 351, and 361, respectively. Thus the charge signals generated in CCDs 311-314 during frame 1 are stored in memory circuits 331, 341, 351, and 361 during the “write 1” period. After the “write 1” period, charge signals stored in memory circuits 331 and 341 are read out during the “read 1A” period, and charge signals from memory circuits 351 and 361 are read out during the “read 1B” period. The signals are subsequently used to produce frame 1 of the video image on a display screen.

After the frame 1 signals are stored in the memory circuits, CCDs 311-314 are exposed to frame 2 of the light, and the CCDs generate a second set of charge signals indicative of the light pattern. After the frame 2 exposure period has ended, the second set of charge signals are read out of the CCDs using the vertical and horizontal shift registers. Once the second set of charge signals are converted to digital signals, they are stored in memory circuits 332, 342, 352, and 362 during the “write 2” period. After the “write 2” period, charge signals stored in memory circuits 332 and 342 are read out during the “read 2A” period, and subsequently, charge signals stored memory circuits 352 and 362 are read out during the “read 2B” period. The signals are then used to produce frame 2 of the video image on a display screen.

After the frame 2 signals are stored in the memory circuits, CCDs 311-314 are exposed to frame 3 of the light, and the CCDs generate a third set of charge signals indicative of the light pattern. After the frame 3 exposure period has ended, the third set of charge signals are read out of CCDs, converted to digital signals, and stored in memory cells 331, 341, 351, and 361 during the “write 3” period. After the “write 3” period, the third set of charge signals are read out of the memory circuits and used to produce frame 3 of the video image on a display screen. The process is repeated for subsequent video frames.

The FIG. 7 timing diagram illustrates the fast frame rate achieved in a tiled CCD array. The time delay between a frame exposure and the video output for that frame is reduced. This is because a first set of signals are stored in memory circuits 331, 341, 351, and 361 while, at the same time, a second set of signals are read out of memory circuits 332, 342, 452, and 362.

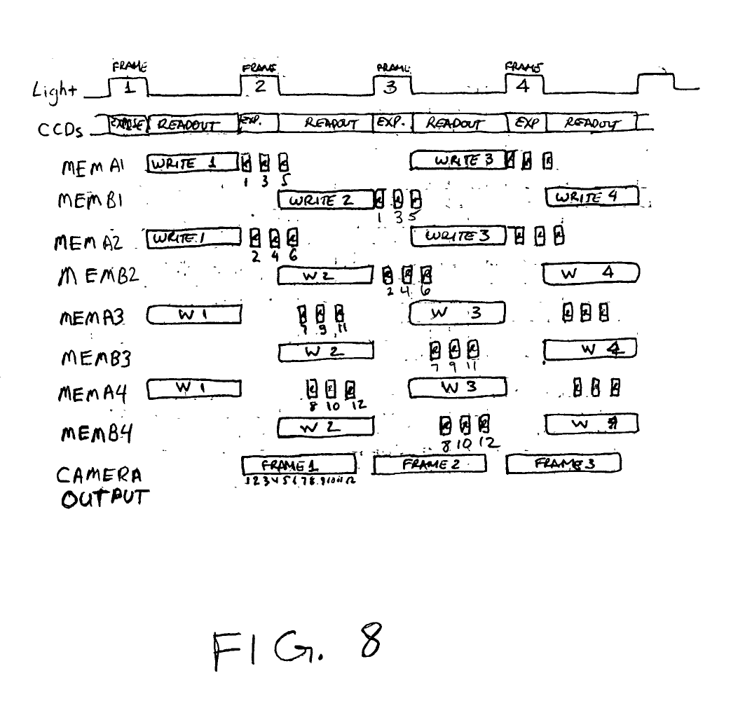

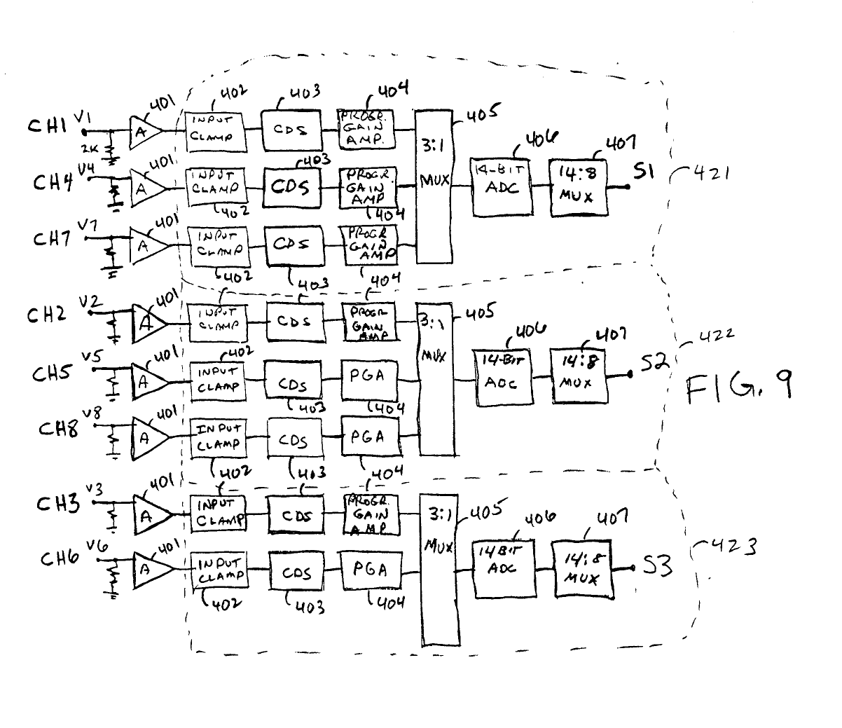

Techniques of the present invention may also be used with simultaneous exposure and readout sensors (such as interline transfer CCDs). FIG. 8 illustrates the process of writing signals from the CCDs into the memory circuits using interline transfer CCDs. Interline transfer CCDs have columns of shift registers next to each column of pixels. Further details of interline transfer CCDs are discussed in U.S. Patent Application ______ to Wen et al., filed concurrently herewith, entitled “Large Area, Fast Frame Rate Charge Coupled Device” (Attorney Docket Number 013843-003200US), which is incorporated by reference herein.

CCD sensors can be exposed to a continuous source of light or a pulsed source of light as shown in FIG. 8. The CCD sensors integrate these continuous or pulsed sources of light during the sensor frame transfer period. At the end of this period, the resulting charge is transferred into the frame storage area adjacent to each pixel in the CCD. Thus, CCD photosites in the CCD sensors integrate the continuous or pulsed sources of light for each frame to produce one charge signal per pixel.

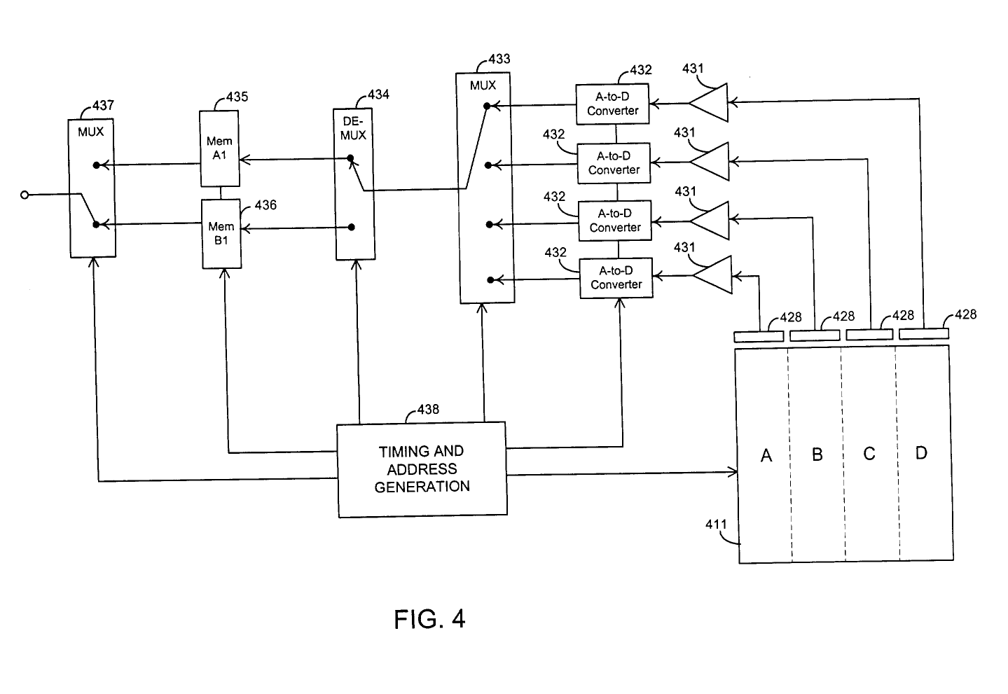

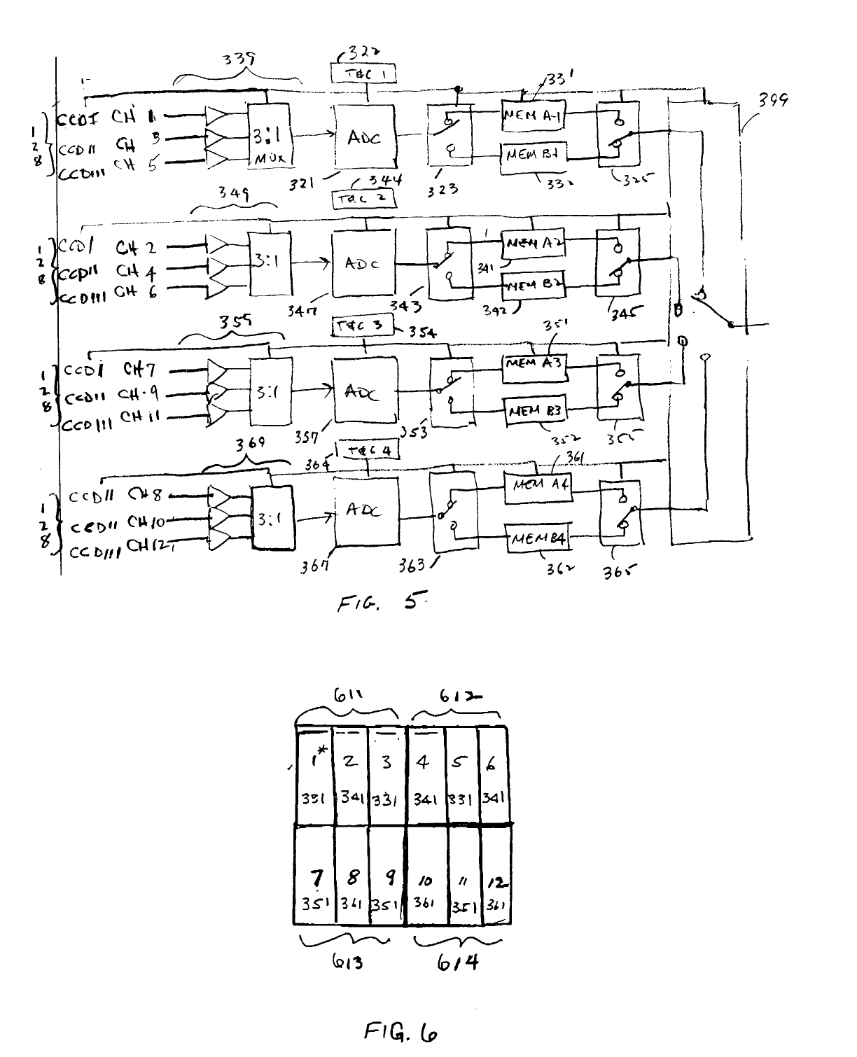

CCDs 611-614 in FIG. 6 are used as an example in the timing diagram of FIG. 8. In the example of FIGS. 6 and 8, the signals from each of the channels 1-12 are read of the CCDs separately (e.g., as shown in FIG. 4). Signals from CCD 611 are stored in one of memory circuits A1 or B1. Signals from CCD 612 are stored in memory circuits A2 or B2. Signals from CCD 613 are stored in memory circuits A3 or B3. Signals from CCD 614 are stored in memory circuits A4 or B4.

Referring to FIG. 8, frame 1 is first formed at the photosites during the frame 1 exposure period. The signals from frame 1 are read out of the CCDs using the horizontal and vertical shift registers. Then, the signals from frame 1 written into memory circuits A1, A2, A3, and A4.

Light from frame 2 is then integrated at the CCD photosites. Signals from frame 1 are read out of the memory circuits in the following sequence: signals from channel 1, signals from channel 2, signals from channel 3, signals from channel 4, signals from channel 5, signals from channel 6, etc. in numerical sequence until signals from channel 12 are read out.

Signals from frame 2 are read out of the CCDs and written into memory circuits B1, B2, B3, and B4. Subsequently, light from frame 3 is sensed and integrated on the CCD photosites. Signals from frame 2 are read out of the memory circuits in numerical sequence from channel 1 to channel 12.

The process of storing charge signals in the memory circuits and then reading them out repeats for each subsequent video frame. FIG. 8 illustrates that the techniques of the present invention can also provide a high frame rate with simultaneous exposure and readout CCDs with multiple channels that sense images from a continuous source of light. The time delay between frame exposure and the camera output display for that frame equals only one frame period.

Referring again to FIG. 3, circuit 322 (or other circuitry) provides memory address signals that select the memory addresses in cells 331 and 332 where the signals from A-to-D converter 321 are stored. The memory address signals can also control how signals stored in memory circuits 331 and 332 are read out. Signals are stored in memory circuits 331 and 332 in a configuration that is independent of the orientation of CCD 311. Signals are also stored in memory circuits 341/342, memory circuits 351/352, and memory circuits 361/362 in configurations that are independent of the orientations of CCDs 312-314, respectively.

For example, memory circuits 331/332, 341/342, 351/352, and 361/362 may have memory cells that are arranged in rows and columns. Signals from row 1 of pixels read out of CCD 311 may be stored in the first row of memory cells in circuits 331 and 332. Signals from subsequent rows of pixels are stored in subsequent rows of memory cells. Signals from column 1 of pixels read out of CCD 311 may be stored in the first column of memory cells in circuits 331 and 332. Signals from subsequent columns of pixels can be stored in subsequent columns of memory cells.

Signals from row 1 of pixels read out of CCD 312 can be stored in the first row of memory cells in circuits 341 and 342, with subsequent rows of pixels stored in subsequent memory cells. Signals from column 1 of pixels read out of CCD 312 can be stored in the first column of memory cells, with subsequent columns of pixels stored in subsequent memory cells.

When signals are read out of the memory circuits, the signals are used to produce a video frame on a display screen. The pixel signals are read out of pixel rows in CCDs 311-312 from top to bottom and displayed in rows of frame portions 221-222 from top to bottom. Also, the pixels signals are read out of pixel columns of CCDs 311-312 from left to right and displayed in columns of frame portions 221-222 from left to right. Therefore, the portions of the video frames formed by CCD tiles 311-312 are oriented exactly the same way as image was detected by the CCDs. The techniques of the present invention also ensure that the frame portions 223-224 from CCDs 313-314 have the correct orientations as will now be discussed.

CCD sensors 313 and 314 are rotated with respect to CCDs 311 and 312 as shown in FIG. 3. Row 1 is at the bottom of CCD 313, and row 1 is on the right side of CCD 314. Column 1 is at the top of CCD 314, and column 1 is on the left side of CCD 313. Therefore, the data signals from pixels in CCDs 313 and 314 cannot be used to produce image portions 223-224 in the same manner as signals from CCDs 311 and 312. Because pixel signals are displayed the same for each frame portion (top to bottom and left to right), the frame portions from CCDs 313 and 314 will be oriented differently than frame portions from CCDs 311 and 312. The video display monitor has no knowledge of how CCDs are oriented with respect to each other in the array. Therefore, the signals from CCDs 313-314 are reoriented before being sent to the video display monitor.

Signals from the pixels in CCDs 313 and 314 are stored into and read out of memory devices according to the techniques of the present invention. These techniques ensure that frame portions 223-224 are oriented the same way as the light that falls on CCDs 313 and 314.

Signals from the pixels of CCD 313 are transferred out of CCD 313 first using circuitry 128. The signals are then amplified by amplifier 126 and converted to digital signals by A-to-D converter 357. De-multiplexer 353 then stores the signals in memory circuit 351 or memory circuit 352. Timing RAM circuit control 354 provides the memory addresses that determine which memory cells in circuits 351/352 the signals are stored in. Signals from one of memory circuits 351/352 are output by multiplexer 355, while signals are stored in the other one of memory circuits 351/352. Signals from the pixels of CCD 314 are stored into and read out of memory circuits 361 and 362 in the same fashion using A-to-D converter 367, de-multiplexer 363, multiplexer 365, and timing RAM control 364.

The memory address signals from timing circuit 354 are configured so that signals from CCD 313 are stored in rows and columns of the memory cells as discussed herein. For example, signals from pixel row 1 of CCD 313 can be stored in the last row of memory cells in circuits 351 and 352. The signals from row 2 of CCD 313 are then stored in the second to last row of memory cells in circuits 351 and 352.

Signals from subsequent rows of pixels are stored in adjacent rows of memory cells until the signals from the last row of pixels are stored in the first row of memory cells. Signals from the first column of pixels are stored in the first column of memory cells. Signals from subsequent columns of pixels in CCD 313 are stored in subsequent columns of memory cells.

Signals from the pixels are now stored in memory circuits 351 and 352 in the same orientation in which they were sensed by CCD 313. The signals are then read out of memory circuits 351/352 using multiplexer 355. The image signals from the first row of memory cells in circuits 351 and 352 are read out first, then the second row of memory cells, then the third row of memory cells, etc. with the last row of memory cells being read out last.

Within each row of memory cells, signals are read starting from the first column of memory cells and continuing sequentially to the last column of memory cells. Thus, the signals from pixels in CCD 313 are reoriented by circuits 351-355. The data stream output of multiplexer 355 contains signals beginning with the top row of pixels and continuing with each row of pixels below that one, with the bottom row 1 of pixels output last. The first signal output from multiplexer 355 from each row of pixels is from pixel column 1, and the last signal from each row of pixels is from the last column of pixels.

The pixel signals from CCD 313 are then displayed in frame portion 223 from top to bottom for each row and from left to right for each column. By reorienting the pixel signals when they are stored in memory circuits 351 and 352, the pixel signals are displayed in frame portion 223 with the same orientation as the light pattern that falls on CCD 313.

The pixel signals from CCD 314 may also be reoriented so that frame portion 224 is independent of the orientation of CCD 314. Signals from column 1 of pixels in CCD 314 can be stored in row 1 of the memory cells in circuits 361/362. Signals from subsequent columns of pixels are stored in subsequent rows of the memory cells in sequential order. Thus, signals from columns of pixels in CCD 314 are stored in rows of the memory cells in order to reorient the pixel signal columns so that they are treated as rows of pixel signals.

Signals from the rows of pixels in CCD 314 are stored in columns of the memory cells in circuits 361/362 so that they are treated as columns of pixel signals. Signals from row 1 of pixels in CCD 314 are stored in the last column of memory cells in circuits 361/362. Signals from row 2 of pixels in CCD 314 are stored in the second to last column of the memory cells, etc. until the last row of pixels are stored in column 1 of the memory cells.

Signals from the pixels are stored in memory cells in circuits 361 and 362 according to the same orientation in which they were sensed by CCD 314. When the signals are read out of memory circuits 361/362 using multiplexer 365, the image signals from the first row of memory cells in circuits 361 and 362 are read out first. Then, the second row of memory cells are read out, then the third row of memory cells are read out, etc. with the last row of memory cells being read out last as with the previous memory cells. Within each row of memory cells, signals from the first column of memory cells are read out first, and signals from the last column of memory cells are read out last.

The rows of pixel signals from memory circuits 361/362 are displayed in frame portion 224 from top to bottom. The columns of pixel signals from circuits 316/362 are displayed from left to right as with the previous frame portions. Because the pixel signals from the CCDs are reoriented in the memory circuits, the pixels signals can be read out of the memory circuits and displayed in the same manner for each CCD in the array.

The pixel signals read from memory circuits 331, 341, 351, and 361 are displayed as one video frame, while another frame of pixel signals are being stored in memory circuits 332, 342, 352, and 362. By using two memory cells for each CCD, the frame rate of the video image can be increased, because the time period between each video frame is only the time it takes to read data from the memory circuits and transfer the data to the display screen. The frame rate is not slowed down by the additional time it takes to store data from the CCDs into the memory cells. Data is stored in one memory circuit, while data is read from another memory circuit. Signals can be read out of the four memory devices and displayed on a display screen at a very fast rate appropriate for video cameras.

Also, the circuitry of FIG. 3 provides a high frame rate for a tiled CCD array, without decreasing the frame rate below the maximum frame rate for a single CCD. Each CCD is treated separately in FIG. 3, because four sets of circuit elements are used to download and to store pixel signals for each of the CCD sensors. Subsequently, the pixels signals are read out of the four memory circuits at a fast data transfer rate (4×write rate) to produce a frame of the image as discussed above at the maximum CCD frame rate. Data can be read out of the memory circuits four times as fast as it is read into the memory circuits.

In another embodiment of the present invention, the pixel signals from each of the CCDs may be stored in the memory circuits without being reoriented as discussed above. For each of the CCDs, the memory address signals can cause the pixels signals to be stored in memory cells according to the order that they are read out of the CCDs. This technique does not take into account the orientation of each CCD.

However, when the pixel signals are read out of memory circuits 331/332, 341/342, 351/352, and 361/362, they are reoriented to take into account the orientation of each individual CCD. Circuits 322, 344, 354, and 364 also output memory address signals that determine the order that pixel signals stored in the memory cells are read out of the memory circuits. The memory address signals do not have to cause the pixel signals to be read out of the memory circuits in the same order that they were read into the memory circuits.

For example, the memory address signals can cause the pixel signals from an entire column (column 1) at the top of CCD 314 to be read out of memory circuits 361/362 as the first row of signals. Signals from subsequent columns are read out of memory circuits 361/362 from the top to the bottom of CCD 314. The pixel signals in each column are read of the memory circuits from left to right with respect to their order in CCD 314 (ending with row 1).

The signals from the columns of pixels are then displayed from top to bottom in frame portion 224. The signals from the rows of pixels are displayed from left to right. Thus, in this embodiment of the invention, the pixel signals are reoriented when they are read out of the memory circuits so that output signals from the multiplexers are independent of the particular orientation of each sensor.

A further embodiment of the present invention is shown in FIG. 4. The pixels in a charge coupled device may be divided into a number of channels. For example, CCD 411 shown in FIG. 4 is divided into four channels A, B, C, and D.

Separate horizontal shift registers, summing wells, amplifiers, and A-to-D converters are used for each channel in a CCD. Each horizontal shift register is coupled to receive signals from pixels in only one channel of pixels in the CCD.

For example, circuit elements 428 correspond to circuit elements 128 in FIG. 1. A separate circuit 428 is coupled to each channel in CCD 411. Circuits 428 each receive signals from columns of pixels in the corresponding channel of CCD 411. The signals output by circuits 428 are amplified by corresponding ones of amplifiers 431 and converted to digital signals by corresponding ones of A-to-D converters 432.

Multiplexer 433 is used to join signals from pixels in all of the columns in CCD 411 into a single data stream at the output of multiplexer 433. De-multiplexer 434 then writes pixel signals in for one frame in memory circuit 435 and pixel signals for another frame in memory circuit 436. Multiplexer 437 reads signals out of one of memory circuits 435 or 436 while signals are written into the other memory circuit to increase the frame rate as discussed above.

Timing and address generation circuit 438 controls outputs a plurality of clock signals. The clock signals control the transfer of data through the horizontal shift registers and the transmission gates in circuits 428, A-to-D converters 432, multiplexer 433, de-multiplexer 434, and multiplexer 437. Circuit 438 also outputs memory address signals that control the memory locations for the pixel signals as discussed above with respect to FIG. 3. The memory address signals from circuit 438 may cause pixel signals from CCD 411 to be re-oriented when they are stored in memory circuits 435 and 436. When the pixel signals are read out of memory circuits 435 and 436, they are ordered in a sequence that allows them to be easily displayed in the same orientation that the CCD 411 pixels sensed the light.

Referring again to FIG. 3, video signal processing (VSP) chips are examples of chips that may perform the functions of A-to-D converters 321/347/3571367. Many types of VSP chips that are designed to process signals from CCDs can be used with the present invention. FIG. 9 illustrates further details of examples of VSP chips that can be used with the present invention. Three VSP chips 421-423 are shown in FIG. 9. A CCD that has 8 channels can be used with the three VSP chips 421-423 as shown in FIG. 9.

Signals from the 8 channels in the charge coupled device are amplified by pre-amplifiers 401. FIG. 9 has eight pre-amplifiers 401, one for each channel in the corresponding CCD sensor. Each VSP chip 421-423 includes at least one input clamp 402, one correlated double sampler 403, and one programmable gain amplifier 404 for each channel.

Each VSP chip 421-423 also has a 3:1 multiplexer 405, a 14-bit analog-to-digital converter 406, and a 14:8 multiplexer 407. These circuit elements are coupled together as shown in FIG. 9. An example of a VSP chip that may be used with the present invention is an AD9814 manufactured by Analog Devices Inc., of Norwood Mass. Further details of the operation of the AD9814 are discussed in AD9814 1999 Datasheet entitled “Complete 14Bit CCD/CIS Signal Processor,” Rev. 0, pages 1-15, which is incorporated herein by reference.

Each VSP chip 421-423 samples the input waveforms using CDS 403. The sampled signals from each channel are amplified using programmable gain amplifiers 404. Multiplexers 405 multiplex the signals from two or three channels onto one signal line. The signals are then converted to 14 bit digital signals by A-to-D converters 406. Multiplexers 407 multiplexes the 14 bit signals into 8 bit output words. Each multiplexer 407 provides signals from two or three CCD channels to output terminals S1, S2, or S3 as shown in FIG. 9.

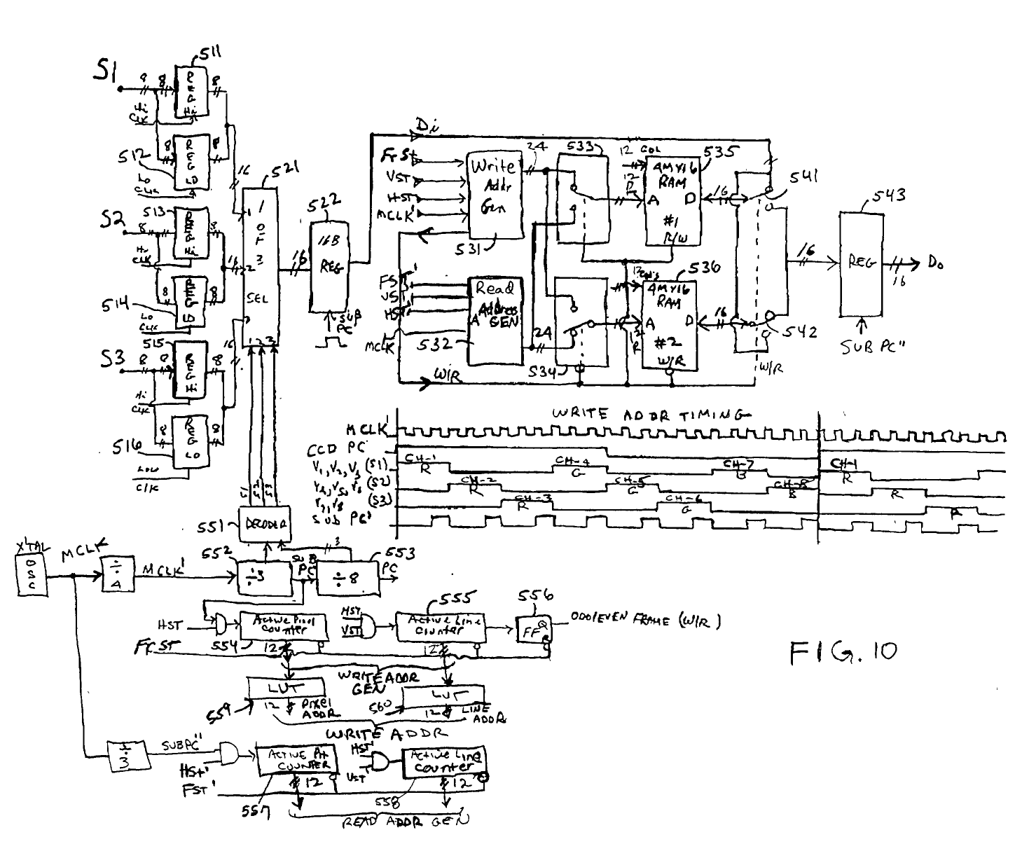

Further details of memory circuits 331/332, 341/342, 351/352, and 361/362 are now discussed. Referring to FIG. 10, output terminals S1, S2, and S3 (from FIG. 9) are coupled to inputs of 8 bit registers 511-516. Registers 511-516 stores the 8 bit words from the VSP chips. Clock signal CLK controls the shifting of signals into and out of registers 511-516. When CLK is HIGH, a first set of 8 bit words at terminals S1 -S3 are stored in registers 511, 513, and 515. When CLK is LOW, a second set of 8 bit words at terminals S1-S3 are stored in registers 512, 514, and 516.

The signals stored in registers 511-516 are then transferred into 16 bit register 522. Multiplexer 521 alternately couples registers 511-516 to registers 522. During a first period of time, 16 bits from registers 511 and 512 are shifted into 16 bit register 522. During a second period of time, 16 bits from registers 513 and 514 are shifted into 16 bit register 522. During a third period of time, 16 bits from registers 515 and 516 are shifted into 16 bit register 522. Decoder 551 controls the timing of when signals from registers 511-516 are shifted into register 522.

After a set of 16 bit signals are stored in register 522, the signals are shifted out of register 522 and written into RAM memory circuit 535 or RAM memory circuit 536. Another clock signal SUB PC′ controls the shifting of signals through shift register 522 and into memory circuits 535-536. Switches 541-542 control whether signals from register 522 are stored in memory circuit 535 or memory circuit 536. Memory circuits 535 and 536 may have any appropriate number of memory cells (e.g., 4M×16 RAM).

Write address generation circuit 531 outputs 24 address signals that determine the order in which the 16 bit signals are stored in and subsequently read out of memory circuits 535 and 536.

Write address generation circuit 531 accepts four input signals FrSt (frame start), VST (vertical start), HST (horizontal start), and MCLK′. Signals MCLK′, HST, VST, and FrSt may be generated by timing and control logic circuitry. Clock signals MCLK′, PC, and SUB PC′ are shown graphically in FIG. 10. Circuit 552 generates clock signal SUB PC′ in response to clock signal MCLK′. Clock signal SUB PC′ has a period that is three times as long as the period of clock signal MCLK′. Circuit 553 generates clock signal PC in response to clock signal SUB PC′. Clock signal PC has a period that is eight times as long as the period of clock signal SUB PC′.

Further details of write address generation circuit 531 are shown at the bottom of FIG. 10. Active pixel counter 554 generates 12 bit write generation address signals. The 12 bit address output signals of active pixel counter 554 are used to select each of the 2048 columns of memory cells in memory circuits 535 and 536.

Active line counter circuit 555 also generates 12 bit write address generation signals. The 12 bit address output signals of active line counter 555 are used to select each of the 2048 rows of memory cells in memory circuits 535 and 536. Active pixel counter 554 and active line counter 555 generate the write address generation signals in response to signals HST, VST, SUB PC′, and FrSt as shown in FIG. 10.

Read address generation circuit 532 outputs 24 bit address signals that select the memory locations where the 16 bit signals from register 522 are read from memory circuits 535 and 536. Read address generation circuit 532 accepts four input signals FrSt′ (frame start), VST′ (vertical start), HST′ (horizontal start), and MCLK. Signals MCLK, HST′, VST′, and FrSt′ may be generated by timing and control logic circuitry.

Further details of read address generation circuit 532 are shown at the bottom of FIG. 10. Active pixel counter 557 generates 12 bit read address signals. The 12 bit address output signals of active pixel counter 557 are used to select each of the 2048 columns of memory cells in memory circuits 535 and 536.

Active line counter circuit 558 also generates 12 bit read address generation signals. The 12 bit address output signals of active line counter 558 are used to select each of the 2048 rows of memory cells in memory circuits 535 and 536. Active pixel counter 557 and active line counter 558 generate the read address generation signals in response to signals HST′, VST′, SUB PC″, and FrSt′ as shown in FIG. 10. Note in this example the read address generator reads four times faster than the write address generator writes.

The circuitry of FIG. 10 can be used to provide a fast frame rate in a tiled CCD array. A first set of pixel signals from a CCD are stored into memory circuit 535 during a first period of time. The first set of signals may represent a first frame of a video image. Subsequently, a second set of pixels signals from the CCD representing a second frame are written into memory circuit 536, while the first set of signals is simultaneously read out of memory circuit 535. The first set of signals is then used to produce a frame of an image on a display screen.

A third set of pixel signals from the CCD representing a third frame are written into memory circuit 535, while the second set of signals is simultaneously read out of memory circuit 536. This process repeats so that pixel signals from one frame are stored, while from a previous frame are read out of memory and used to display an image frame. The time delay between a frame exposure and outputting the reconstructed video for that frame is minimized using this technique.

The time delay to write pixel signals into memory circuits 535 and 536 is based on the delay for one CCD, because the pixel signals are written into memory along separate circuit paths using separate circuit elements. However, the time delay to read pixel signals out of memory circuits 535 and 536 and to create an image frame is based on for all four CCDs, because the output data of the reconstruction circuitry for all four CCDs is merged into a single data stream. Therefore, the digitized binned pixel signals are read out of memory circuits 535 and 536 four times as fast as they are written into memory circuits 535/536.

Signal W/R controls when signals from register 522 are stored in memory circuit 535 and when signals from register 522 are stored in memory circuit 536. Signal FrSt resets input of flip-flop 556. Flip-flop 556 provides read/write signal (W/R) at its Q output. Signal W/R is provided to the select inputs of multiplexers 533 and 534 as well as the read/write inputs of memory circuits 535 and 536.

The W/R signal determines if multiplexers 533 and 534 couple write address generation circuit 531 to memory circuit 535 or to memory circuit 536. When signal W/R is HIGH, multiplexer 533 provides the 24 bit write address signals from write address generation circuit 531 to the address input of memory circuit 535. The write address signals determine the order in which pixel signals are written into memory cells in circuit 535.

Memory circuit 535 is in write mode when W/R is HIGH, and switch 541 couples register 522 to the D input of memory 535. Pixel signals from all eight channels in a CCD are transferred out of register 522 and stored in memory circuit 535. Pixel signals from an entire video frame are written in memory 535 in one half cycle of W/R.

When the W/R signal is LOW, multiplexer 534 provides the 24 bit address signals from write address circuit 531 to the address input of memory circuit 536. Memory circuit 536 is in write mode when W/R is LOW, and switch 542 couples register 522 to the D input of memory 536. Pixel signals from all eight channels in a CCD are transferred out of register 522 and stored in memory circuit 536. Pixel signals from a second video frame are stored in memory 536 in one half cycle of W/R.

When W/R is LOW, multiplexer 534 couples read address generation circuit 532 to memory 535. Switch 541 couples the D output of memory 535 to the input of register 543. Read address generation circuit 532 provides read address signals to memory 535. The read address signals select the order in which the pixel signals are read out of memory cells in memory circuit 535. The pixel signals indicative of the first frame are read out of memory 535 and transferred into register 543, while signals indicative of the second frame are shifted out of register 522 and written into memory 536.

When W/R is HIGH, multiplexer 533 couples read address generation circuit 532 to memory 536. Read address generation circuit 532 provides read address signals to memory 536. The read address signals select the order in which the pixel signals are read out of memory cells in memory circuit 536. Switch 542 couples the D output of memory 536 to the input of register 543. The pixel signals stored in memory 536 are then read out of memory 536 and transferred to register 543, while signals indicative of a third video frame are stored in memory 535.

Thus, pixel signals from one frame are stored in memory 536 while pixel signals from a previous frame are simultaneously read out of memory 535. Also, pixel signals from one frame are stored in memory 535 while pixel signals from a previous frame are simultaneously read out of memory 536. This technique provides a higher frame rate for the reconstructed output video image. A faster frame rate is important for CCD imaging devices of the present invention that are used as video cameras.

The time delay for each frame is only the time it takes to download signals from one CCD into memory 535 or memory 536, because the signals from each CCD are downloaded in parallel using separate circuits. Each CCD in the array stores its pixel signals in a separate set of memory circuits 535 and 536. Signals from all four CCD sensors can be read out of four corresponding memory circuits and used to form a video frame in a very short time.

Each address signal from circuit 531 selects the row and the column where each pixel signal is written into memory circuits 535 and 536. The address signals from circuit 531 cause the pixels signals from the CCD to be stored in a configuration within memory circuits 535 and 536 that is not dependent on the direction that the pixel signals are read out of the CCD.

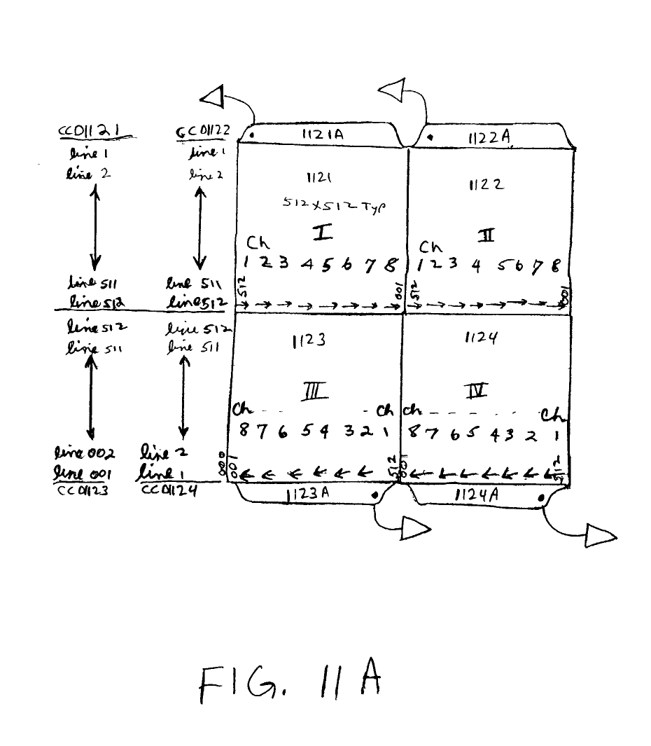

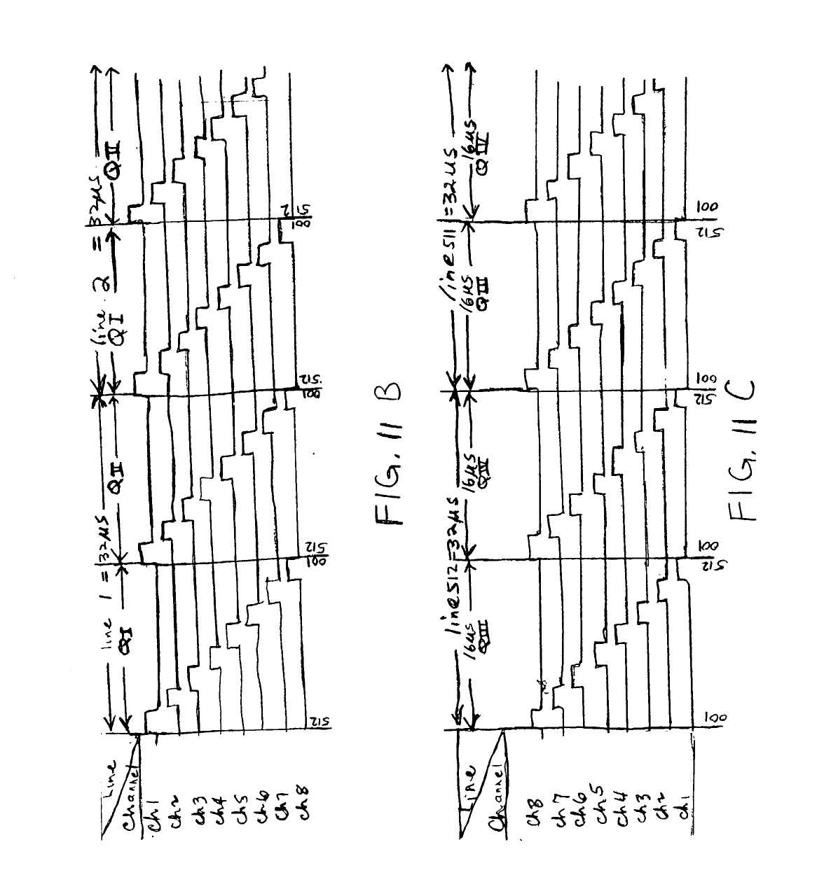

FIG. 11A illustrates the problem. Four CCD sensors 1121-1124 are shown in FIG. 11A. Each CCD sensor 1121-1124 has a set of horizontal shift registers 1121A-1124A, respectively. Signals generated by pixels in the CCD sensors are transferred into the horizontal shift registers using vertical shift registers (not shown) within each CCD. The pixel signals can be summed together internally using a binning technique. For example, 16 pixel signals in 4 adjacent rows and four adjacent columns may be summed together in a 4×4 binning technique. If CCDs 1121-1124 each have 2048 rows and 2048 columns of pixels, then the 4×4 binned pixel signals output by the summing wells comprise 512 rows and 512 columns of signals per CCD sensor.

In the example of FIG. 11A, pixel signals for one frame may be read out of CCD 1121 row by row from the top edge to the bottom edge of CCD 1121 using registers 1121A. The binned pixel signals are output by the summing well starting from line 1 (i.e., row 1) and continuing through line 512 (i.e., row 512). At the same time, pixel signal from the same frame may be read out of CCD 1123 row by row from the bottom edge to the top edge of CCD 1123 using registers 1123A. The binned pixel signals are output by the summing well starting from line 1 and continuing through line 512.

If the circuitry and signals shown in FIGS. 9-10 are the same for all four CCDs in the array, then the order that the pixels signals are stored in corresponding sets of memory circuits 535 and 536 is dependent upon how the pixel signals are read out of the CCD. The pixel signals from CCD 1121 that are stored in the first row of memory cells are from the top row (line 1) of pixels in CCD 1121. The pixel signals from CCD 1123 that are stored in the first row of memory cells are from the bottom row (line 1) of pixels in CCD 1123. The pixel signals are treated the same for all four CCDs when they are read out of memory and used to reconstruct a frame of the image. Therefore, the portion of the frame sensed by CCD 1123 will be rotated 180 degrees with respect to the portion of the frame sensed by CCD 1121 (as shown in FIG. 2B).

The same problem occurs with respect to the way the columns of pixel signals are read out differently from each CCD sensor. For example, columns of the pixel signals are read out of CCDs 1121-1122 from right to left, while the columns of pixel signals are read out of CCD 1123-1124 from left to right. If the pixel signals are stored in memory and processed the same way for each CCD sensor 1121-1124, then the portions of the video frames from each CCD sensor have a different orientation. For example, the portion of the video frame from CCD 1122, is rotated 180 degrees with respect to the portion of the video frame from CCD 1124.

To correct this problem, the pixel signals can be written into memory 535 and 536 in a configuration that is independent of the direction that the pixel signals are read out of the CCD and the orientation of each CCD within the CCD array. For example, signals from the bottom row of signals in each CCD sensor are stored in row 1 of the memory cells (in circuits 535 and 536). Signals from subsequent rows of pixels (from the bottom to the top of each CCD) are stored in consecutive rows of the memory cells. Signals from the leftmost column of pixels in each CCD sensor are stored in column 1 of the memory cells (in circuits 535 and 536). Signals from subsequent columns of pixels (from the left to the right of each CCD) are stored in consecutive columns of the memory cells.

Alternatively, pixel signals can be written into memory cells in circuits 535 and 536 in any pattern or configuration. The pixel signals are then read out of circuits 535 and 536 using read address bits in a configuration that is independent of the direction that the pixels signals were read out of the CCDs. In this embodiment, the write address signals (but not the read address signals) dictate patterns that re-orient the order of the pixel signals so that they are independent of the readout direction of each CCD.

The timing diagrams FIGS. 11B-11C illustrates how the order of the pixels signals has changed when the pixels signals are read out circuits 535 and 536. CCD 1121 is in quadrant I (QI) of the array, CCD 1122 is in quadrant II (QII) of the array, CCD 1123 is in quadrant III (QIII) of the array, and CCD 1124 is in quadrant IV (QIV) of the array.

FIG. 11B illustrates signals from CCDs 1121-1122 after they are read out of memory circuits 535 and 536. As shown in FIG. 11B, the binned pixel signals are read out of memory circuits 535 and 536 starting with horizontal line 1 of CCDs 1121-1122 and continuing sequentially to horizontal line 512 of CCDs 1121-1122. Line 1 from CCD 1121 is read out first, then line 1 from CCD 1122, then line 2 from CCD 1121, then line 2 from CCD 1122, then line 3 from CCD 1121, etc. Signals from the 64 binned rows in each channel are read out first from channel 1, then channel 2, then channel 3, then channel 4, then channel 5, then channel 6, then channel 7, and then channel 8 in CCDs 1121-1122.

FIG. 11A illustrates the order that signals from CCDs 1123-1124 are read out of memory circuits 535-536. Binned pixel signals are read out of memory circuits 535 and 536 starting with horizontal line 512 of CCDs 1123-1124 and continuing sequentially to horizontal line 1 of CCDs 1123-1124. Line 512 from CCD 1123 is read out first, then line 512 from CCD 1124, then line 511 from CCD 1123, then line 511 from CCD 1124, then line 510 from CCD 1123, etc. Signals from the 64 binned rows in each channel are read out first from channel 8, then channel 7, then channel 6, then channel 5, then channel 4, then channel 3, then channel 2, and then channel 1 in CCDs 1123-1124.

All of the signals sensed by CCDs 1121-1122 in one frame are read out of memory circuits 535-536 first. Subsequently, all of the signals sensed by CCDs 1123-1124 in that frame are read out of memory circuits 535-536. Thus, the output data stream of image reconstruction circuitry 151 for a particular video frame starts with signals from CCDs 1121 and 1122 (e.g., as shown in FIG. 11 B), and ends with signals from CCDs 1123 and 1124 (e.g., as shown in FIG. 11C).

Thus, the signals read out the four sets of memory circuits 535/536 are ordered in a configuration. This configuration is independent of how the pixels signals are actually read out of each CCD. This configuration is also independent of the physical orientation of each CCD within the x-y plane in the CCD array. Thus, the techniques of the present invention correct for the effect shown in FIG. 2B that occurs when one CCD is rotated with respect to the others (e.g., CCDs 313-314 in FIG. 3).

The output signals of the four sets of memory circuits 535/536 begin with the top rows in CCDs 1121-1122 and continue down to the bottom rows of CCDs 1121-1122. Then, signals from CCDs 1123-1124 are added to the data stream starting from the top rows and ending with the bottom rows of CCDs 1123-1124. Within each row, the signals begin with the left column and continue to the right columns. This pattern is preserved for all of the CCD sensors regardless of the order that the pixel signals are read out of each sensor.

Data stored in lookup tables 559-560 determines the row and the column memory address signals that are output by write address generation circuit 531. These row and column address signals select a write configuration for memory circuits 535 and 536. The data in lookup tables 559-560 ensures that the pixel signals from each CCD are written into memory circuits 535 and 536 in a configuration that is independent of the direction that the pixels signals are read out of that CCD (and independent of the physical orientation of each CCD within the CCD array).

Read address generation circuit 532 outputs row and the column memory address signals that determine a read configuration for data in memory circuits 535 and 536. The pixel signals from each CCD are also read out of memory circuits 535 and 536 in a configuration that continues to be independent of the direction that the pixels signals are read out of that CCD (and independent of the physical orientation of each CCD within the CCD array). The rest of the signals and circuitry shown in FIG. 5 may be the same for each CCD sensor.

The write address bits output by circuit 531 are generated such that the 16 signal bits from register 522 are written into RAM 535 or 536 at the desired reconstruction addresses during each write cycle. This may be accomplished via a logic array look-up tables (e.g., lookup tables 559 and 560) within the write address generator 531 which outputs the desired reconstruction addresses to RAM 535 or 536 for each write cycle.

During the subsequent read cycle, the read address bits cause the signal bits to be read out directly from RAM 535 or 536 in the desired order. This technique ensures that the pixel signals are also read out of the memory in a configuration that is independent of the orientation of each CCD in the CCD array and the direction that the pixel signals were read out of each CCD.

Alternatively this technique can be used to reconstruct during the read cycle instead of the write cycle. However the preferred embodiment for this invention is to reconstruct during the write cycle because RAM's can usually be read out faster than they can be written into, and we are required to read out at least four times faster than we write if four tiled CCDs are used to achieve the same data transfer rate for the output signals.

If the physical orientation of one or more of the CCDs in the CCD array is changed,. the image reconstruction techniques of the present invention can compensate for this change. For example, CCD 311 can be rotated 90 degrees with respect to its orientation in FIG. 3. The write address signals from write address circuit 531 or the read address signals from read address circuit 532 can be reprogrammed to cancel out the change in the orientation of CCD 311. The write address signals can be changed by reprogramming the address data in lookup tables 559 and 560. Alternatively, the read address signals can be reprogrammed. The write and read address signals can be reprogrammed to store and read the pixel signals in a configuration that is independent of the orientation of CCD 311 with respect to CCDs 312314.

If re-synchronization and re-clocking of the counters is required, timing and control generator circuitry can also be reprogrammed for signals HST, VST, HST′, and VST′. These signals may be programmed using the USB bus, for example.

FIG. 10 also illustrates a timing diagram for signals V1, V2, V3, V4, V5, V6, V7, and V8. Signals V1-V8 are the output signals from the eight channels of a CCD. The timing diagram shows the order of the eight signals output by the three VSP chips. Further details of a Large Area Charge Coupled Device Camera are discussed in U.S. Patent Application ______(Attorney Docket Number 013843-003500US) to Tinnerino et el., filed concurrently herewith, which is incorporated by reference herein.

While the present invention has been described herein with reference to particular embodiments thereof, a latitude of modification, various changes, and substitutions are intended in the present invention. In some instances, features of the invention can be employed without a corresponding use of other features, without departing from the scope of the invention as set forth. Therefore, many modifications may be made to adapt a particular configuration or method disclosed, without departing from the essential scope and spirit of the present invention. It is intended that the invention not be limited to the particular embodiment disclosed, but that the invention will include all embodiments and equivalents falling within the scope of the claims.

What is claimed is:

1. A method for reconstructing near real time video frames, the method comprising:
providing signals received from a plurality of charge coupled devices, including a first set of signals indicative of a first video frame and a second set of signals indicative of a second video frame;
writing the first set of the signals into first memory devices during a first period of time;
reading the first set of the signals out of the first memory devices during a second period of time that is after the first period of time;
writing the second set of the signals into second memory devices during the second period of time; and
reading the second set of the signals out of the second memory devices during a third period of time that is after the second period of time.

2. The method of claim 1 wherein providing signals received from the charge coupled devices further comprises converting signals from the charge coupled devices into digital signals using analog-to-digital converters to provide the first and the second sets of the signals.

3. The method of claim 2 wherein providing signals received from the charge coupled devices further comprises amplifying the signals from the charge coupled devices to provide amplified signals to the analog-to-digital converters.

4. The method of claim 1 wherein writing the first set of the signals into the first memory devices further comprises coupling the first set of the signals to inputs of the first memory devices using de-multiplexers.

5. The method of claim 4 wherein writing the second set of the signals into the second memory devices further comprises coupling the second set of the signals to inputs of the second memory devices using the de-multiplexers.

6. The method of claim 1 wherein reading the first set of the signals out of the first memory devices further comprises coupling the first memory devices to output terminals using multiplexers.

7. The method of claim 4 wherein reading the second set of the signals out of the second memory devices further comprises coupling the second memory devices to the output terminals using the multiplexers.

8. The method of claim 1 wherein writing the signals from the charge coupled devices further comprises writing the signals from four charge coupled devices arranged in a 2×2 array, the first memory devices comprising four memory circuits, and the second memory devices comprising four memory circuits.

9. The method of claim 1 further comprising:
generating a plurality of control signals that control when the first set of the signals are written into the first memory devices during the first period of time and when the second set of the signals are written into the second memory devices during the second period of time.

10. The method of claim 9 wherein the control signals control when the first set of the signals are read from the first memory devices during the second period of time and when the second set of the signals are read from the second memory devices during the third period of time.

11. The method of claim 1 further comprising:
generating memory addresses that select memory cells where the first set of the signals are stored in the first memory devices and where the second set of the signals are stored in the second memory devices.

12. The method of claim 11 wherein:
the memory addresses cause the first set and the second set of the signals to be written into memory cells within the first and the second memory devices in a configuration that is independent of directions that the signals are read out of the charge coupled devices.

13. The method of claim 11 wherein:
the memory addresses cause the first set and the second set of the signals to be read out of memory cells within the first and the second memory devices in a configuration that is independent of directions that the signals are read out the charge coupled devices.

14. The method of claim 1 further comprising:
writing a third set of the signals that are indicative of a third frame into the first memory devices during the third period of time; and
reading the third set of the signals out of the first memory devices during a fourth period of time that is after the third period of time.

15. Image reconstruction circuitry comprising:
de-multiplexers that are each coupled to receive signals generated by pixels in one of a plurality of charge coupled devices;
first memory circuits that are each coupled to a first output of one of the de-multiplexers and that store first sets of video frames;
second memory circuits that are each coupled to a second output of one the de-multiplexers and that store second set of video frames; and
multiplexers that are each coupled to one of the first memory circuits and one of the second memory circuits.

16. The image reconstruction circuitry of claim 15 further comprising:
video signal process chips that include analog-to-digital converters coupled to receive signals from the charge coupled devices, to convert the signals from the charge coupled devices to digital signals, and to provide the digital signals to the de-multiplexers.

17. The image reconstruction circuitry of claim 16 further comprising:
amplifier circuits that are coupled to receive signals from the charge coupled devices, to amplify the signals from the charge coupled devices, and to provide the amplified signals to the video signal processing chips.

18. The image reconstruction circuitry of claim 15 further comprising:
timing circuits that provide control signals to the de-multiplexers, the control signals controlling when a first set of signals indicative of a first video frame are written into the first memory circuits during a first period of time, and when a second set of signals indicative of a second video frame are written into the second memory circuits during a second period of time.

19. The image reconstruction circuitry of claim 14 wherein the de-multiplexers are coupled to receive signals generated by four charge coupled devices,
each of the charge coupled devices comprising at least eight parallel channels, and
further comprising a second set of multiplexers, wherein each of the second set of multiplexers provides signals from the eight channels in one of the charge coupled devices to one of the de-multiplexers.

20. The image reconstruction circuitry of claim 15 further comprising:
address generation circuits that provide memory addresses,
the memory addresses causing the signals to be written into memory cells within the first and the second memory circuits in a configuration that is independent of directions that the signals are read out of the charge coupled devices.

21. The image reconstruction circuitry of claim 15 further comprising:
address generation circuits that provide memory addresses,
the memory addresses causing the signals to be read out of memory cells within the first and the second memory circuits in a configuration that is independent of directions that the signals are read out of the charge coupled devices,
wherein the signals are written into of the first and the second memory circuits in a configuration that dependent upon the directions that the signals are read out of the charge coupled devices.

22. A method for providing video images, the method comprising:
providing signals indicative of electromagnetic radiation impinging upon pixels in a plurality of charge coupled devices;
reading the signals out of each of the charge coupled devices in a direction;
providing memory address signals;
writing a first set of the signals from the charge coupled devices in first memory cells that are selected by the memory address signals, the first set of signals being indicative of a first video frame; and
writing a second set of the signals from the charge coupled devices in second memory cells that are selected by the memory address signals, the second set of signals being indicative of a second video frame,
wherein the memory address signals cause the first and the second sets of signals to be written into each of the first and the second memory cells in configurations that are independent of the directions that the signals are read out of the charge coupled devices.

23. The method of claim 22 further comprising:
reading the first set of signals from the first memory cells while the second set of signals is written into the second memory cells;
writing a third set of signals from the charge coupled devices in the first memory cells, wherein the memory address signals cause the third set of signals to be written into the first memory cells in a configuration that is independent of the direction that the signals are read out of the charge coupled device; and
reading the second set of signals from the second memory cells while the third set of signals is written into the first memory cells.

24. A method for providing video data, the method comprising:
generating signals in a plurality of charge coupled devices;
reading the signals out of each of the charge coupled devices in a direction;
converting the signals to digital signals;
providing memory address signals;
storing the digital signals in first and second memory circuits; and
reading the digital signals from the first and the second memory circuits,
wherein the memory address signals cause the digital signals to be read out of the first and the second memory circuits in configurations that are independent of the directions that the signals are read out of the charge coupled devices.

25. The method of claim 24 wherein a first subset of the digital signals stored in the first memory devices are used to produce a first video frame, and a second subset of the digital signals stored in the second memory devices are used to produce a second video frame.

26. The method of claim 25 wherein the first subset of the digital signals are read from the first memory devices when the second subset of the digital signals are stored in the second memory devices.

27. A method for providing video images, the method comprising:
providing signals indicative of electromagnetic radiation impinging upon pixels in a plurality of charge coupled devices arranged in an M×N array;
reading the signals out of each of the charge coupled devices in a direction;
providing memory address signals;
writing the signals from the charge coupled devices into memory cells that are selected by the memory address signals, the signals being indicative of a first video frame,
wherein the memory address signals cause the signals to be written into each of the memory cells in a configuration that is independent of the physical orientation of each charge coupled device in the array.

28. The method of claim 27 wherein the memory address signals cause the signals to be written into each of the memory cells in a configuration that is independent of the direction that the signals are read out of each of the charge coupled devices.

29. The method of claim 28 wherein each of the charge coupled devices has two or more channels.

30. The method of claim 27 wherein the memory address signals are programmable to compensate for changes in the physical orientation of one or more of the charge coupled devices so that the signals continue to be written into each of the memory cells in a configuration that is independent of the physical orientation of each charge coupled device in the array.

31. The method of claim 27 wherein the video images are produced in near real-time.
